(19) United States
(12) Patent Application Publication
(10) Pub. No.: US 2010/0191907 A1
(43) Pub. Date: Jul. 29, 2010

(54) RAID Converter and Methods for Transforming a First RAID Array to a Second RAID Array Without Creating a Backup Copy

(75) Inventor: Mark Ish, Sandy Springs, GA (US)

Correspondence Address: SMITH FROHWEIN TEMPEL GREENLEE BLAHA LLC, TWO RAVINIA DRIVE, SUITE 700, ATLANTA, GA, 30346, US

(73) Assignee: LSI Corporation, Milpitas, CA (US)

(21) Appl. No.: 12/359,461

(22) Filed: Jan. 26, 2009

(51) Int. Cl. G06F 12/00; G06F 12/16

(52) U.S. Cl. 711/114; 711/162; 711/E12.001

(57) ABSTRACT

A system transforms data structures absent the need for a backup copy. The system transforms a first logical store in an initial logical arrangement to a desired logical arrangement where the data structures of the logical arrangements are different. The system uses a select sequence of data operations that moves data from its origin in the initial logical arrangement to a target location in the desired logical arrangement. The system generates and properly locates parity information when so desired. The system executes a subsequent data operation in accordance with an indication that the previous data operation was successful. Each subsequent data operation uses the source location from the previous data operation. A non-volatile memory element holds information concerning a present data operation to enable a rollback operation when a present data operation is unsuccessful.

### TECHNICAL FIELD

The present application relates generally to data-storage systems and, more particularly, to systems and methods for migrating or expanding a redundant array of inexpensive or independent disks (RAID) based storage volume.

### BACKGROUND

The acronym “RAID” is an umbrella term for data-storage schemes that can divide and replicate data among multiple hard-disk drives. When several physical hard-disk drives are set up to use RAID technology, the hard-disk drives are said to be in a RAID array. The RAID array distributes data across several hard-disk drives, but the array is exposed to the operating system as a single logical disk drive or data storage volume.

Although a variety of different RAID system designs exist, all have two key design goals, namely: (1) to increase data reliability and (2) to increase input/output (I/O) performance. RAID has seven basic levels corresponding to different system designs. The seven basic RAID levels, typically referred to as RAID levels 0-6, are as follows. RAID level 0 uses striping to achieve increased I/O performance. The term “striped” means that logically sequential data, such as a single data file, is fragmented and assigned to multiple physical disk drives in a round-robin fashion. Thus, the data is said to be “striped” over multiple physical disk drives when the data is written. Striping improves performance and provides additional storage capacity. The fragments are written to their respective physical disk drives simultaneously on the same sector. This allows smaller sections of the entire chunk of data to be read off the drive in parallel, providing improved I/O bandwidth. The larger the number of physical disk drives in the RAID system, the higher the bandwidth of the system, but also the greater the risk of data loss. Parity is not used in RAID level 0 systems, which means that RAID level 0 systems are not fault tolerant. Consequently, when any physical disk drive fails, the entire system fails.

In RAID level 1 systems, mirroring without parity is used. Mirroring corresponds to the replication of stored data onto separate physical disk drives in real time to ensure that the data is continuously available. RAID level 1 systems provide fault tolerance from disk errors because all but one of the physical disk drives can fail without causing the system to fail. RAID level 1 systems have increased read performance when used with multi-threaded operating systems, but also have a reduction in write performance.

In RAID level 2 systems, redundancy is used and physical disk drives are synchronized and striped in very small stripes, often in single bytes/words. Redundancy is achieved through the use of Hamming codes, which are calculated across bits on physical disk drives and stored on multiple parity disks. If a physical disk drive fails, the parity bits can be used to reconstruct the data. Therefore, RAID level 2 systems provide fault tolerance. That is, failure of a single physical disk drive does not result in failure of the system.

RAID level 3 systems use byte-level striping in combination with interleaved parity bits and a dedicated parity disk. RAID level 3 systems require the use of at least three physical disk drives. The use of byte-level striping and redundancy results in improved performance and provides the system with fault tolerance. However, use of the dedicated parity disk creates a bottleneck for writing data due to the fact that every write requires updating of the parity data. A RAID level 3 data storage system can continue to operate without parity and no performance penalty is suffered in the event that the parity disk fails.

RAID level 4 is essentially identical to RAID level 3 except that RAID level 4 systems employ block-level striping instead of byte-level or word-level striping. Because each stripe is relatively large, a single file can be stored in a block. Each physical disk drive operates independently and many different I/O requests can be handled in parallel. Error detection is achieved by using block-level parity bit interleaving. The interleaved parity bits are stored in a separate single parity disk.

RAID level 5 uses striping in combination with distributed parity. In order to implement distributed parity, all but one of the physical disk drives must be present for the system to operate. Failure of any one of the physical disk drives necessitates replacement of the physical disk drive. However, failure of a single one of the physical disk drives does not cause the system to fail. Upon failure of one of the physical disk drives, any subsequent data read operations can be performed or calculated from the distributed parity such that the physical disk drive failure is masked from the end user. If a second one of the physical disk drives fails, the system will suffer a loss of data. Accordingly, the data storage volume or logical disk drive is vulnerable until the data that was on the failed physical disk drive is reconstructed on a replacement physical disk drive.

RAID level 6 uses striping in combination with dual distributed parity. RAID level 6 systems require the use of at least four physical disk drives, with two of the physical disk drives being used for storing the distributed parity bits. The system can continue to operate even if two physical disk drives fail. Dual parity becomes increasingly important in systems in which each virtual disk is made up of a large number of physical disk drives. RAID level systems that use single parity are vulnerable to data loss until the failed drive is rebuilt. In RAID level 6 systems, the use of dual parity allows a virtual disk having a failed physical disk drive to be rebuilt without risking loss of data in the event that a physical disk drive of one of the other physical disk drives fails before completion of the rebuild of the first failed physical disk drive.

Many variations on the seven basic RAID levels described above exist. For example, the attributes of RAID levels 0 and 1 may be combined to obtain a RAID level known as RAID level 0+1. When designing a RAID-based storage system, the system designer will select a particular RAID level based on the needs of the user (i.e., cost, capacity, performance, and safety against loss of data).

However, it is possible that over time the RAID-based storage system will cease to meet the user's needs. Often times, the user will replace the RAID-based storage system having the current RAID level with a new RAID-based storage system having a different RAID level. In order to replace the current RAID-based system or RAID array, the data stored in the current RAID array is backed up to a temporary backup storage system. The virtual disk parameters are also stored in a backup storage system. Once the data and virtual disk parameters have been backed up, the new RAID array is put in place and made operational. The backed up data is then moved from the backup storage system to the new RAID array. The stored virtual disk parameters are used to create a mapping between the virtual disk of the new RAID array and the physical disk drives of the new RAID level system. For large data capacity virtual disks, RAID migration can require hours or even days of downtime before the new RAID array can be exposed to users.

To avoid the downtime required migrating a logical data volume from first RAID level to a data volume that uses a second RAID level that is different from the first RAID level, “online” or software-based migration solutions have been deployed. These “online” solutions, configure a new data storage array using the second RAID level and allocate storage space in a temporary storage volume before starting an iterative process of identifying a block of data that is not being currently accessed by user's of the system, locking the block of data, copying the block of data to the temporary storage volume (i.e., creating a backup copy of the “locked” block of data), manipulating a working copy of the “locked” block of data as required to populate the new data storage array, and writing the manipulated data to the new data volume. Once the data transfer process has been confirmed successful, the “locked” block of data in the “online” data volume is unlocked. That is, the previously inaccessible or “locked” block of data is once again accessible to users of the data. While an “online” migration is more acceptable to users of the data, such an “online” migration process requires a relatively large temporary storage volume and multiple data write operations to insure data integrity. In addition, the relatively large temporary data storage volume must be backed up or otherwise safeguarded from possible data loss.

### SUMMARY

An embodiment of a RAID converter transforms data in a logical store arranged in an initial RAID array to a second logical store arranged in a desired RAID array where the respective data structures of the initial RAID array and the desired RAID array are different from each other. The RAID converter comprises a memory element, a processor and a non-volatile memory element. The memory stores a select sequence of data operations that for every repeating set of stripes moves a respective strip from an original location in the initial RAID array to a target location in the desired RAID array. The select sequence of data operations when executed by the processor accounts for generates and locates a parity strip in each respective stripe when the desired RAID array includes parity information. The processor executes each subsequent data operation from the select sequence of data operations in accordance with an indication that a previous data operation was successful. The non-volatile memory element holds information responsive to the present data operation. When the indication reveals that the previous data operation was unsuccessful, the processor uses the information in the non-volatile memory element to execute a rollback operation until the previous data operation succeeds.

An embodiment of a method for transforming a logical store from an initial logical arrangement to a desired logical arrangement where the initial logical arrangement comprises a first data structure and the desired logical arrangement comprises a second data structure different from the first data structure includes the steps of identifying a first data structure of the initial logical arrangement and a second data structure of the desired logical arrangement, arranging a set of M physical disk drives in accordance with the second data structure, identifying a select sequence of data operations that moves data from an original location in the initial logical arrangement to a target location in the desired logical arrangement, the select sequence of data operations accounting for, generating and locating parity information when the desired logical arrangement includes parity information, and repeatedly executing the select sequence of data operations until completion including recording information responsive to a present data operation in the desired logical arrangement and confirming a successful completion of the present data operation before commencing a subsequent data operation from the select sequence of data operations, otherwise repeating the present data operation until successful.

The figures and detailed description that follow are not exhaustive. The disclosed embodiments are illustrated and described to enable one of ordinary skill to make and use the RAID converter and methods for transforming a RAID-based data store. Other embodiments, features and advantages of the systems and methods will be or will become apparent to those skilled in the art upon examination of the following figures and detailed description. All such additional embodiments, features and advantages are within the scope of the RAID converter and methods as defined in the accompanying claims.

### BRIEF DESCRIPTION OF THE FIGURES

The RAID converter and methods for transforming a first RAID array to a second RAID array can be better understood with reference to the following figures. The elements and features within the figures are not necessarily to scale, emphasis instead being placed upon clearly illustrating the principles for transforming a logical data volume without creating a backup copy. Moreover, in the figures, like reference numerals designate corresponding parts throughout the different views.

FIG. 1 is a schematic diagram illustrating a data structure of a logical store using a conventional RAID-level 0 arrangement of distributed data elements.

FIG. 2 is a schematic diagram illustrating a data structure of a logical store using a conventional RAID-level 5 arrangement of distributed data elements.

FIG. 3 is a schematic diagram illustrating a subset of a sequence of steps for transforming a RAID-level 0 logical store to a RAID-level 5 logical store when a physical disk drive is added to the array.

FIG. 4 is a schematic diagram illustrating a second subset of a sequence of steps for transforming a RAID-level 0 logical store to a RAID-level 5 logical store when parity information for a particular stripe is stored in a physical disk drive other than the new disk drive.

FIG. 5 is a functional block diagram illustrating an embodiment of a RAID converter.

FIG. 6 is a flow diagram illustrating an embodiment of a method for transforming a logical data volume.

FIG. 7 is a flow diagram illustrating an embodiment of a method for transforming a stripe in a logical data volume.

### DETAILED DESCRIPTION

A RAID converter coupled to a redundant array of inexpensive disks (RAID) includes a processor, a memory, an array interface and a non-volatile memory element. The RAID converter transforms a logical store arranged in an initial RAID array to a desired RAID array. The initial RAID array is arranged in a first data structure or RAID level. The desired RAID array is arranged in a second data structure or RAID level that is different from the first data structure or RAID level. The RAID converter can be configured to transform any initial RAID array to a desired RAID array. The RAID converter is particularly well suited for transforming RAID arrays when a larger logical store is desired. That is, when physical disk drives are being added to increase data storage capacity. The memory element stores at least one sequence of data operations that when executed moves the data from a source location in the initial RAID array to a target location in the desired RAID array. The select sequence of data operations accounts for, generates, and locates parity information in each respective stripe when the desired RAID array includes parity information.

The processor is coupled to the memory and is configured to execute the sequence of data operations. Each data operation is confirmed successful before moving to a subsequent data operation. The non-volatile memory element is coupled to the processor and is configured to store information concerning the present data operation. When the processor receives an indication that a particular data operation failed, the processor executes a rollback operation, which uses the information from the non-volatile memory element to recover. When a data operation fails, the processor repeats the previous data operation until the operation is successful. By verifying each strip or block of data was moved successfully and only once from a first physical disk drive to a second physical disk drive, the RAID converter ensures data integrity without the creation of a backup copy of the entire logical store.

A transformation of a logical data storage volume from some RAID levels to some other RAID levels is straightforward. For example, when transforming or converting a logical store arranged in a RAID level 0 array to a RAID level 1 array, the conversion includes a copy from a first physical disk drive to a second physical disk drive. An array arranged in RAID level 0 separates the data in the logical store in discrete blocks, which are distributed sequentially across the physical disk drives in the array. For example, in a two drive RAID level 0 array odd numbered blocks can be placed on the first physical disk drive and even numbered blocks can be placed on the second physical disk drive. An array arranged in RAID level 1 mirrors or produces an identical copy of all data onto all of the drives in the array. Consequently, to transform a RAID level 0 array to a RAID level 1 array the RAID converter steps through the sequential blocks of data in the RAID level 0 array and copies each in sequential order onto each of the physical disk drives of the desired RAID level 1 array.

By way of further example, a transformation or conversion from a RAID level 0 array to a RAID level 10 array is also straightforward. An array arranged in RAID level 10 includes features of both a RAID level 0 array and a RAID level 1 array. The data stored in a RAID level 10 array is separated such that odd numbered and even numbered data blocks are stored together but separate from one another. That is, odd numbered data blocks are mirrored across a first set of two or more physical disk drives and even numbered data blocks are mirrored across a second set of two or more physical disk drives different from the first set of physical disk drives. Accordingly, to transform or convert a RAID level 0 array to a RAID level 10 array, the RAID controller steps through the sequential blocks of data in the RAID level 0 array and copies each in alternative sequential order onto each of the physical disk drives of the desired RAID level 10 array.

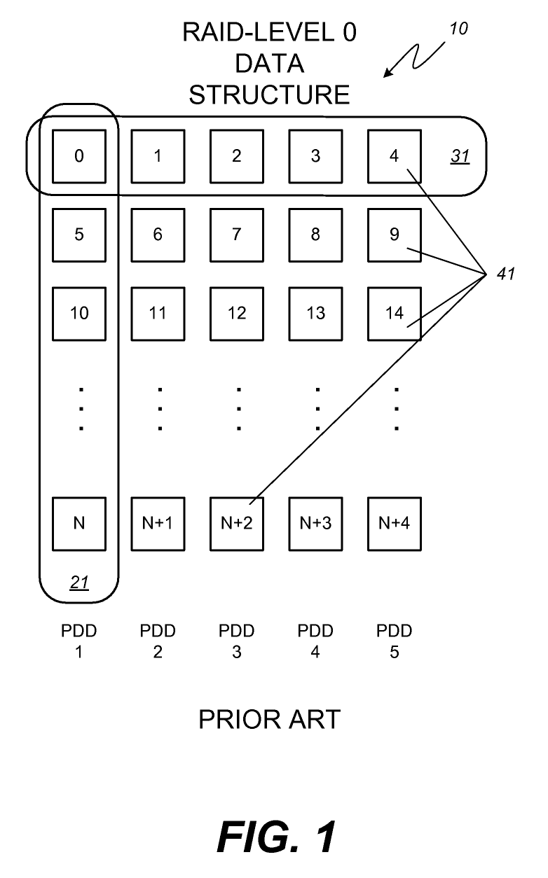

A RAID converter tasked with converting a logical store from a RAID level 0 array to a RAID level 5 array performs a more involved sequence of data operations. FIG. 1 illustrates a data structure of a logical store using a conventional RAID-level 0 arrangement of distributed data elements. The logical store 10 is an array of data elements or strips 41. The size in bytes of each individual strip 41 is the same and configurable at the time the RAID array is created. Each column in the array represents a respective physical disk drive. The illustrated array includes five physical disk drives in registration with each other from left to right across the array or data structure. A first physical disk drive 21 in physical disk drive location 1 (PDD1) includes strips 41, which respectively store the data from data blocks 0, 5, 10, . . . N. The integer N is determined upon creation of the RAID level 0 array and is a function of the capacity of the smallest physical disk drive in the array and the size of each strip. A second physical disk drive in physical disk drive position 2 (PDD2) includes data from data blocks or strips 1, 6, 11, . . . N+1. A third physical disk drive in physical disk drive position 3 (PDD3) includes data from data blocks or strips 2, 7, 12, . . . N+2. A fourth physical disk drive in physical disk drive position 4 (PDD4) includes data from data blocks or strips 3, 8, 13, . . . N+3. A last physical disk drive in physical disk drive position 5 (PDD5) includes data from data blocks or strips 4, 9, 14, . . . N+4.

Each row of strips 41 in the array forms a stripe 31. As explained above, information is stored sequentially across the data blocks. For example, if each strip is K bytes in size, the first K bytes of a file or other logical data portion are stored in the strip 41 labeled 0 (the first strip 41 in the first stripe 31 of the first physical disk drive 21). The next K bytes of the file are stored in the strip 41 labeled 1 in the first stripe 31 on the second physical disk drive. When the file exceeds 5×K bytes in size a portion of the file is stored in the next stripe(s) as required.

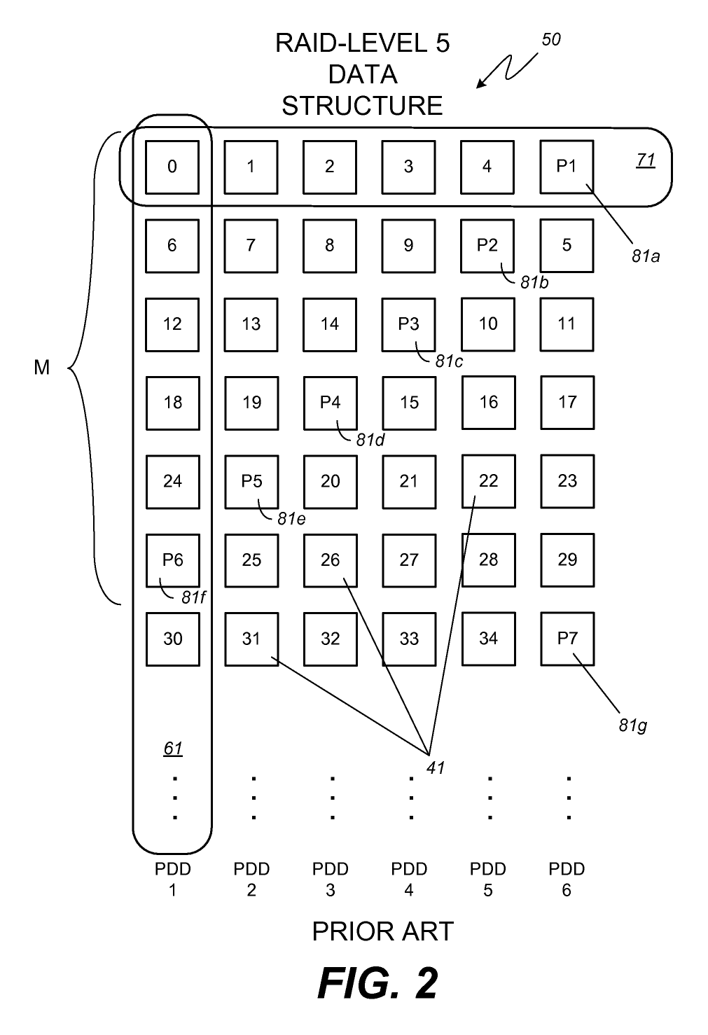

FIG. 2 illustrates a data structure of a logical store using a conventional RAID-level 5 arrangement of distributed data elements. The logical store 50 is an array of data elements or strips 41. The size in bytes of each individual strip 41 is the same and configurable at the time the RAID array is created. Each column in the array represents a respective physical disk drive. The illustrated array includes six physical disk drives. A first physical disk drive 61 includes strips 41, which respectively store the data from data blocks 0, 6, 12, 18, 24, P6, 30, and so on.

Each row of strips 41 in the array forms a stripe 71 and each stripe 71 includes respective parity information 81 responsive to the data stored in the strips 41 of the stripe 71. The illustrated logical store 50 is arranged in a left hand symmetric RAID level 5 array. That is, the parity information 81a-81f (P1, P2, P3, P4, P5, P6) for each stripe 71 is distributed from the right-most physical disk drive to the left-most physical disk drive. This arrangement is repeated every M stripes, as necessary, across the physical disk drives of the array, where M is an integer number of physical disk drives in the array. The RAID level 5 data structure is symmetric because the next subsequent strip 41 or data block is arranged after the parity information 81 for a particular stripe 71 with subsequent strips 41 following thereafter and wrapping over the strips 41 of the same stripe 71. Thus, for an array of six physical disks, the first stripe 71 includes 5 data strips (i.e., data strip 0, data strip 1, data strip 2, data strip 3 and data strip 4) followed by parity information 81a specific to the data stored in the data strips. Whereas, the second stripe moving down the array includes the next five data strips with the first physical disk storing data strip 6, the second physical disk storing data strip 7, the third physical disk storing data strip 8, the fourth physical disk storing data strip 9, the fifth physical disk storing the parity information for the second stripe (i.e., P2) with the sixth physical disk storing data strip 5. As is known, the parity information for a respective stripe is generated by performing a XOR operation over the data stored in the strips 41 of the respective stripe 71.

As with the RAID level 0 array, information is stored sequentially across the numbered strips 41 or data blocks. For example, if each strip is K bytes in size, the first K bytes of a file or other logical data portion are stored in the strip 41 labeled 0 (the first strip 41 in the first stripe 71 of the first physical disk drive 61). The next K bytes of the file are stored in the strip 41 labeled 1 in the first stripe 71 on the second physical disk drive. When the file exceeds 5×K bytes in size a portion of the file is stored in the next stripe(s) and so on as required.

Consequently, the RAID converter includes a separate and distinct sequence of steps for converting an initial RAID array to a desired RAID array. The sequence is dependent on the initial and desired RAID level or data structures and the number of physical disk drives in each of the respective arrays. Consequently, a RAID converter designated to transform or convert a RAID level 0 array to a RAID level 5 array will include a select sequence of data operations for converting a RAID level 0 array of five physical disks to a RAID level 5, left hand, symmetric data structure of six physical disks. The sequence of data operations reconstructs the stripes of the data array in the desired RAID level 5, left hand, symmetric data structure of 6 physical disks. The sequence of data operations can be repeated over every set of M stripes, where M is the number of physical drives in the desired RAID array.

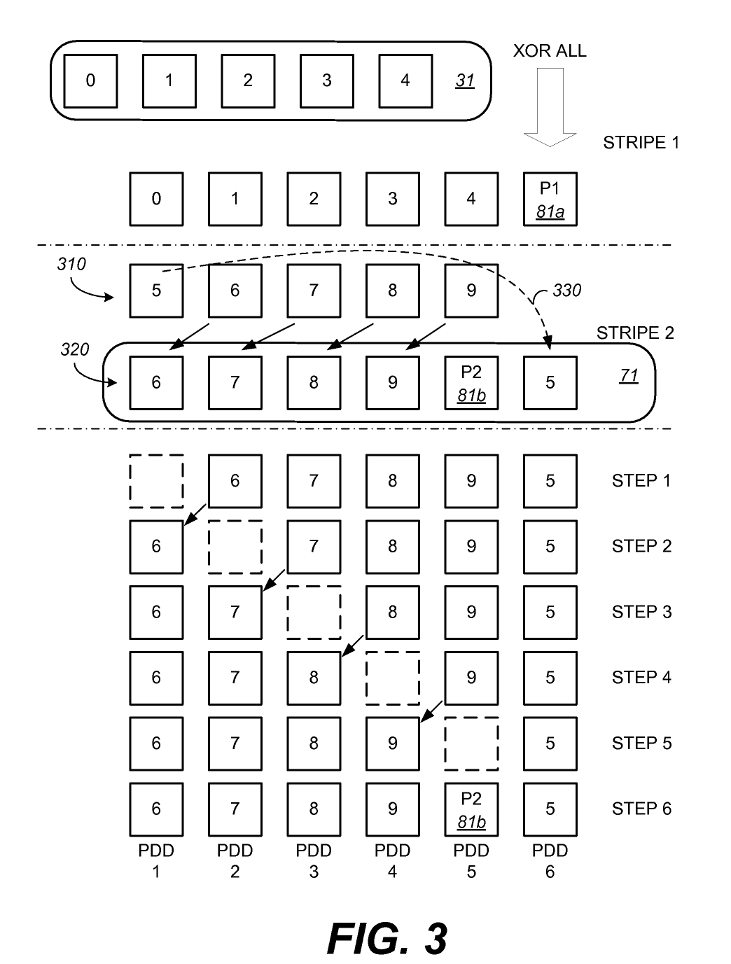

Reference is directed to FIG. 3, which illustrates the conversion process for transforming the first two data stripes when converting a RAID level 0 array of five physical drives to a RAID level 5, left-hand symmetric array of six physical disks. The illustrated embodiment assumes that the new physical disk drive is inserted into the new array in the right most position of the array. Starting at the uppermost row of FIG. 3, stripe 31 (i.e., the first stripe of the RAID level 0 array of FIG. 1) is converted into stripe 71 (i.e., the first stripe of the RAID level 5, left-hand symmetric array of FIG. 2) by performing a XOR operation over the data in each of data strip 0, data strip 1, data strip 2, data strip 3 and data strip 4 and storing the result in the parity information 81a (the sixth physical disk location) to complete stripe 71.

The portion of FIG. 3 between the dashed lines includes an upper row of data strips 310, which represents the second stripe of the RAID level 0 array and a lower row of data strips 320, which represents the second stripe of the RAID level 5, left-hand symmetric array. As described above, the parity information 81b is shifted one physical disk drive position to the left and the fifth data strip moves to the right or to the position of the sixth physical disk drive (as indicated by dashed arrow 330) with subsequent data strips wrapping around from left to right across the second stripe. Stated another way, the initial stripe of data strips or blocks 5, 6, 7, 8, and 9 becomes a desired stripe of data strips or blocks arranged in the order 6, 7, 8, 9, P2, 5, where P2 is the parity information 81b defined by the data within the data strips 6, 7, 8, 9 and 5.

The portion of FIG. 3 below the second dashed line indicates that the second stripe can be transformed by a sequence of six steps or data operations. In step 1, the data in the left most strip (strip 5) is copied to the new physical disk, which was inserted in the right most position. If this data operation is successful and confirmed, step 1 is complete and a new target location depicted by the dashed outline in the first physical drive position of the stripe is identified. Upon completion of step 1, the data strips are arranged in the sequence new target, 6, 7, 8, 9, 5.

Next, in step 2, the data located in the next data strip (i.e., last strip copied +1) or strip 6, is copied to the target location. If this data operation is successful and confirmed, step 2 is complete and a new target location depicted by the dashed outline in the second physical drive position (i.e., the source of strip 6) of the stripe is identified. Upon completion of step 2, the data strips are arranged in the sequence 6, new target, 7, 8, 9, 5.

Thereafter, in step 3, the data located in the next data strip (i.e., last strip copied +1) or strip 7, is copied to the target location. If this data operation is successful and confirmed, step 3 is complete and a new target location depicted by the dashed outline in the third physical drive position (i.e., the source of strip 7) of the stripe is identified. Upon completion of step 3, the data strips are arranged in the sequence 6, 7, new target, 8, 9, 5.

In step 4, the data located in the next data strip (i.e., last strip copied +1) or strip 8, is copied to the target location. If this data operation is successful and confirmed, step 4 is complete and a new target location depicted by the dashed outline in the fourth physical drive position (i.e., the source of strip 8) of the stripe is identified. Upon completion of step 4, the data strips are arranged in the sequence 6, 7, 8, new target, 9, 5.

Next, in step 5, the data located in the next data strip (i.e., last strip copied +1) or strip 9, is copied to the target location. If this data operation is successful and confirmed, step 5 is complete and a new target location depicted by the dashed outline in the fifth physical drive position (i.e., the source of strip 9) of the stripe is identified. Upon completion of step 5, the data strips are arranged in their desired sequence of 6, 7, 8, 9, new target, 5.

The sixth and final step for transforming stripe 2 includes the performance of a XOR operation over the data in each of data strip 5, data strip 6, data strip 7, data strip 8 and data strip 9 and storing the result in the parity information 81b (the fifth physical disk location) in the present target location. If this data operation is successful and confirmed, step 6 is complete and the second stripe is in the desired sequence of 6, 7, 8, 9, P2, 5.

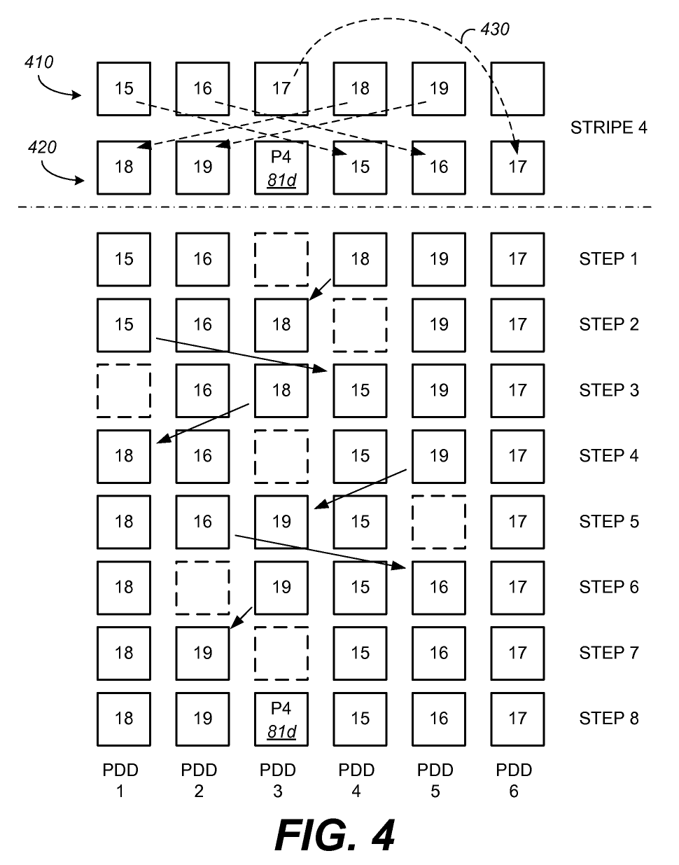

Additional data operations are included in sequences designated for converting stripes where the parity information is not located in the first or sixth physical drive positions. Reference is directed to FIG. 4, which illustrates the conversion process for transforming the fourth data stripe when converting a RAID level 0 array of five physical drives to a RAID level 5, left-hand symmetric array of six physical disks. The illustrated embodiment assumes that the new physical disk drive is inserted into the new array in the right most position of the array. Inserting the new physical disk in any other position will simply change the sequence of the steps taken. Starting at the uppermost row of FIG. 4, that is, the fourth stripe of the RAID level 0 array of FIG. 1 is converted into the fourth stripe of the RAID level 5, left-hand symmetric array of FIG. 2 by shifting (i.e., copying) the data in RAID level 0 strips 15, 16 and 17 three physical disk drive positions to the right, shifting (i.e., copying) the data in RAID level 0 strips 18 and 19 three physical disk drive locations to the left and performing a XOR operation over the data in each of data strip 15, data strip 16, data strip 17, data strip 18 and data strip 19 and storing the result in the parity information 81d (at the third physical disk location) to complete the fourth stripe.

The portion of FIG. 4 above the dashed line includes an upper row of data strips 410, which represents the fourth stripe of the RAID level 0 array and a lower row of data strips 420, which represents the fourth stripe of the RAID level 5, left-hand symmetric array. As described above, the parity information 81d is shifted three physical disk drive positions to the left and the 17^{th} data strip moves to the right three disk drive positions or to the position of the sixth physical disk drive (as indicated by dashed arrow 430) with data strips 15 and 16 inserted in registration with each other to the right of the parity information and subsequent data strips (i.e., 18 and 19) wrapping around from left to right across the fourth stripe. Stated another way, the initial stripe of data strips or blocks 15, 16, 17, 18, and 19 becomes a desired stripe of data strips or blocks arranged in the order 18, 19, P4, 15, 16, 17, where P4 is the parity information 81d defined by the data within the data strips 18, 19, 15, 16, and 17.

The portion of FIG. 4 below the dashed line indicates that the fourth stripe can be transformed by a sequence of eight steps or data operations. In step 1, the data in strip 17 is copied to the new physical disk, which was inserted in the right most position. If this data operation is successful and confirmed, step 1 is complete and a new target location depicted by the dashed outline in the third physical drive position of the stripe is identified. Upon completion of step 1, the data strips are arranged in the sequence 15, 16, new target, 18, 19, 17.

Next, in step 2, the data located in the next data strip (i.e., last strip copied +1) or strip 18, is copied to the target location. If this data operation is successful and confirmed, step 2 is complete and a new target location depicted by the dashed outline in the fourth physical drive position (i.e., the source of strip 18) of the stripe is identified. Upon completion of step 2, the data strips are arranged in the sequence 15, 16, 18, new target, 19, 17.

Thereafter, in step 3, the data located in the 15^{th} data strip (i.e., last strip copied −3), is copied to the target location. If this data operation is successful and confirmed, step 3 is complete and a new target location depicted by the dashed outline in the first physical drive position (i.e., the source of strip 15) of the stripe is identified. Upon completion of step 3, the data strips are arranged in the sequence new target, 16, 18, 15, 19, 17.

In step 4, the data located in the 18^{th} data strip (i.e., last strip copied +3) is copied to the target location. If this data operation is successful and confirmed, step 4 is complete and a new target location depicted by the dashed outline in the third physical drive position (i.e., the source of strip 18) of the stripe is identified. Upon completion of step 4, the data strips are arranged in the sequence 18, 16, new target, 15, 19, 17.

Next, in step 5, the data located in the next data strip (i.e., last strip copied +1) or strip 19, is copied to the target location. If this data operation is successful and confirmed, step 5 is complete and a new target location depicted by the dashed outline in the fifth physical drive position (i.e., the source of strip 19) of the stripe is identified. Upon completion of step 5, the data strips are arranged in the sequence 18, 16, 19, 15, new target, 17.

Thereafter, in step 6, the data located in the 16th data strip (i.e., last strip copied −3) is copied to the target location. If this data operation is successful and confirmed, step 6 is complete and a new target location depicted by the dashed outline in the second physical drive position (i.e., the source of strip 16) of the stripe is identified. Upon completion of step 6, the data strips are arranged in the sequence 18, new target, 19, 15, 16, 17.

Thereafter, in step 7, the data located in the 19th data strip (i.e., last strip copied +3) is copied to the target location. If this data operation is successful and confirmed, step 7 is complete and a new target location depicted by the dashed outline in the third physical drive position (i.e., the source of strip 19) of the stripe is identified. Upon completion of step 7, the data strips are arranged in the desired sequence of 18, 19, new target, 15, 16, 17.

The eighth and final step for transforming stripe 4 includes the performance of a XOR operation over the data in each of data strip 15, data strip 16, data strip 17, data strip 18 and data strip 19 and storing the result in the parity information 81d in the present target location. If this data operation is successful and confirmed, step 8 is complete and the fourth stripe is complete and arranged in the desired sequence of 18, 19, P4, 15, 16, 17.

It should be understood that while the illustrated embodiments depicted in FIG. 3 and FIG. 4 show a particular sequence of data operations for transforming stripes 1, 2 and 4 from an initial RAID level 0 data structure of five physical drives to a desired RAID level 5, left-hand symmetric data structure having six physical drives, the conversion of stripe 3, stripe 5 and stripe 6 will be performed by respective unique sequences of data operations. Similar but unique sets of sequences for converting member stripes from an initial RAID data structure to a desired RAID data structure different from the initial RAID data structure can be identified and stored in a RAID converter to enable RAID array transformations or conversions for a desired number of such conversions.

The RAID converter and methods for transforming a RAID array can be implemented in hardware, software, or a combination of hardware and software. When implemented in hardware, the converter and methods can be implemented using specialized hardware elements and logic. When the converter and methods for are implemented in software, the software can be used to control the various components in an execution system and manipulate the data stored in a RAID array. The software can be stored in a memory and executed by a suitable instruction execution system (microprocessor).

The software can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: a portable computer diskette (magnetic), a random access memory (RAM), a read-only memory (ROM), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner if necessary, and then stored in a computer memory.

A hardware implementation of the RAID converter and methods for transforming a RAID array can include any or a combination of the following technologies, which are all well known in the art: discrete electronic components, a discrete logic circuit(s) having logic gates for implementing logic functions upon data signals, an application specific integrated circuit having appropriate logic gates, a programmable gate array(s) (PGA), a field programmable gate array (FPGA), etc.

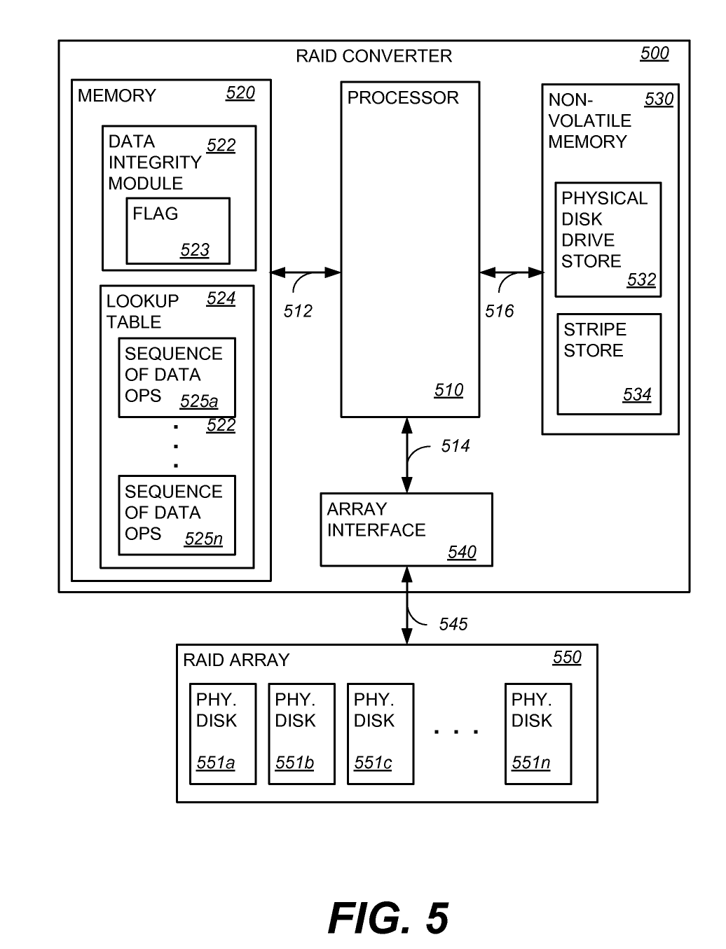

FIG. 5 is a functional block diagram illustrating an embodiment of a RAID converter. The RAID converter 500 includes a processor 510, a memory 520, a non-volatile memory 530 and an array interface 540. The processor 510, the memory 520, the non-volatile memory 530 and the array interface 540 are communicatively coupled via local interfaces. In the illustrated embodiment, the processor 510 is coupled to the memory 520 via a local interface 512. The processor 510 is coupled to the array interface 540 via a local interface 514. The processor 510 is coupled to the non-volatile memory 530 via a local interface 516. Each of the local interface 512, the local interface 514 and the local interface 516 can be, for example but not limited to, one or more buses or other wired or wireless connections, as is known in the art. The local interfaces may have additional elements, which are omitted for simplicity, such as controllers, buffers (caches), drivers, repeaters, and receivers, to enable communications. Further, the local interfaces may include address, control, power and/or data connections to enable appropriate communications among the aforementioned components. Moreover, the local interfaces provide power to each of the processor 510, the memory 520, the non-volatile memory 530 and the array interface 540 in a manner understood by one of ordinary skill in the art. In an alternative embodiment (not shown) the processor 510, the memory 520, the non-volatile memory 530 and the array interface 540 may be coupled to each other via a single bus.

The processor 510 is a hardware device for executing software (i.e., programs or sets of executable instructions), particularly those stored in memory 520. The processor 510 can be any custom made or commercially available processor, a central processing unit (CPU), an auxiliary processor among several processors associated with RAID converter 500, a semiconductor based microprocessor (in the form of a microchip or chip set), or generally any device for executing instructions.

The memory 520 can include any one or combination of volatile memory elements (e.g., random-access memory (RAM), such as dynamic random-access memory (DRAM), static random-access memory (SRAM), synchronous dynamic random-access memory (SDRAM), etc.) and nonvolatile memory elements (e.g., read-only memory (ROM), hard drive, tape, compact disk read-only memory (CD-ROM), etc.). Moreover, the memory 520 may incorporate electronic, magnetic, optical, and/or other types of storage media. Note that the memory 520 can have a distributed architecture, where various components are situated remote from one another, but can be accessed by the processor 510.

The software in the memory 520 may include one or more separate programs or modules each of which comprises an ordered listing of executable instructions for implementing logical functions. In the example embodiment illustrated in FIG. 5, the software in the memory 520 includes data integrity module 522 and lookup table 524. The lookup table 524 includes one or more sequences of data operations 525 that when executed are arranged to transform a set of stripes from a data structure of an initial RAID array to a desired RAID array. As described above, each sequence of data operations 525a through sequence of data operations 525n is unique and designed to transform a particular RAID array having an identified number of physical disk drives and a particular RAID data structure to a desired RAID array with a desired number of physical disk drives and a desired data structure. The individual data operations in each sequence of data operations 525 will be dictated by the data structures of the RAID arrays and the number of physical disk drives assigned to each.

The data integrity module 522 includes logic that determines when the data in a source strip or block has been successfully copied to a target strip or block on another physical disk drive. The data integrity module 522 may use one or more checksums and or one or more cyclic redundancy checks to verify that the data contents have been successfully transferred from the source strip to the target strip. The data integrity module 522 is configured to set a flag 523 to a known state to indicate when the last data operation was successful. The processor 510 executes subsequent data operations after checking the flag 523. In the illustrated embodiment, the flag 523 is integrated in the memory 520. The RAID converter 500 is not so limited. That is, the flag 523 can be implemented in a register, a switch or other devices that can implement a binary signal in other locations in communication with the processor 510.

The non-volatile memory 530 is a memory element that can retain the stored information even when not powered. The non-volatile memory 530 includes a physical disk drive store 532 and a stripe store 534. The physical disk drive store 532 includes a digital representation of the target disk for the present data operation. In a preferred embodiment, the physical disk drive store 532 has a capacity of 2 bytes. Other capacities including those with less storage or more storage than 2 bytes may be used. A storage capacity of 2 bytes can be used to identify 65,536 physical disk drives. The stripe store 534 includes a digital representation of the unique stripe or set of repeating stripes being transformed or converted. In a preferred embodiment, the stripe store 534 has a capacity of 6 bytes. Other capacities including those with less or more storage than 6 bytes can be used. A storage capacity of 6 bytes can be used to identify 65,536³ unique stripes.

The information stored in non-volatile memory 530 can be used by the RAID converter 500 to recover information from RAID level 1 and RAID level 10 to RAID 5 when one of the physical disks fails. Data recovery is possible because the information in the non-volatile memory 530 together with the data structures of the initial RAID array and the desired RAID array provide the necessary information to determine in which stripe and what physical disk was performing a data operation. The RAID converter 500 can even do multiple stripe reconstructions at once as long as they are 1/n stripe separate from each other (where n is the number of drives in the resulting logical data volume).

The array interface 540 includes elements for communicating via one or more protocols over bus 545 to the physical disks 551a-551n of the RAID array 550. The array interface 540 may provide front-end interfaces and back-end interfaces (not shown). A back-end interface communicates with controlled physical disks such as the physical disks 551a-551n. Presently known protocols for communicating with physical disk drives include the advanced technology attachment (ATA) (also known as integrated device electronics (IDE) or parallel advanced technology attachment (PATA), serial advanced technology attachment (SATA), small computer system interface (SCSI), fibre channel (FC) or serial attached SCSI (SAS). A front-end interface communicates with a computer's host bus adapter (not shown) and uses one of ATA, SATA, SCSI, FC, fiber connectivity/enterprise system connection (FICON/ESCON), Internet small computer system interface (iSCSI), HyperSCSI, ATA over Ethernet or InfiniBand. The RAID converter 500 may use different protocols for back-end and for front-end communication.

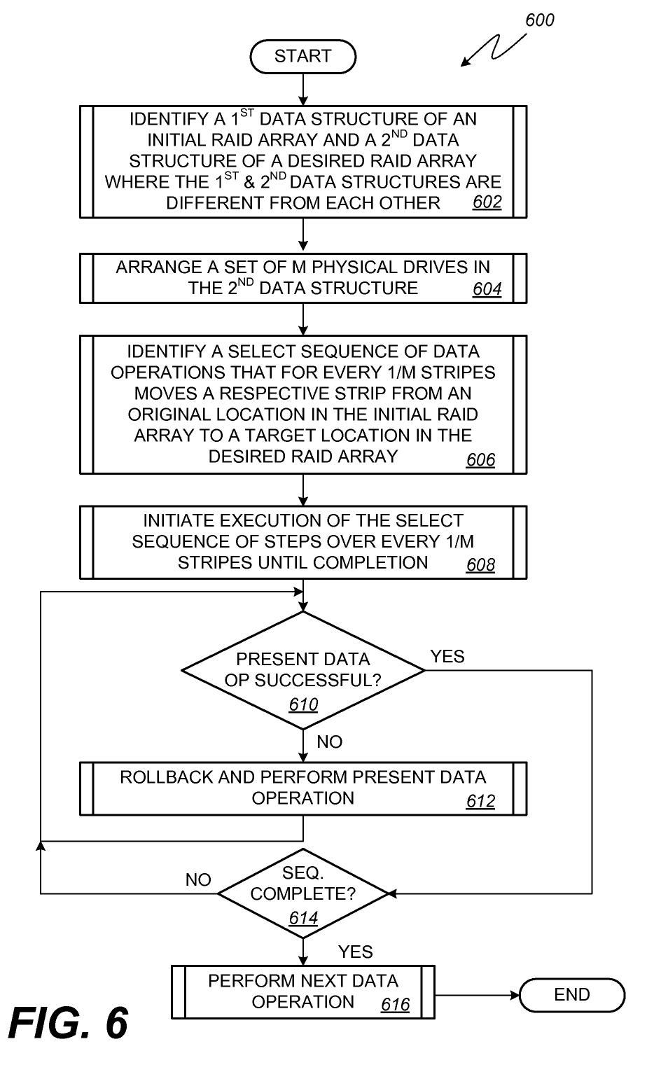

FIG. 6 is a flow diagram illustrating an embodiment of a method for transforming a logical data volume. Method 600 begins with block 602 where a first data structure of an initial RAID array and a second data structure of a desired RAID array are identified. A RAID array is an example of a logical arrangement. As further indicated in block 602, the first and second data structures are different from each other. That is, the logical arrangements are different from each other. In block 604, a set of M physical disk drives are arranged in accordance with the second data structure 604. In block 606 a select sequence of data operations is identified that for every M stripes moves a respective strip from an original location in the initial RAID array to a target location in the desired RAID array. Thereafter, in block 608, a RAID converter 500 initiates execution of the select sequence of steps over every M stripes until completion. Thereafter, in decision block 610 it is determined when the present data operation was successful. When successful, as shown by the flow control arrow labeled “YES” exiting decision block 610, the RAID converter 500 continues with block 614 where the next data operation is performed. Otherwise, when the present data operation failed, as indicated by the flow control arrow labeled “NO” exiting decision block 610, the RAID controller performs a rollback operation and returns to perform the present data operation, as indicated in block 612. As shown by the flow control arrow exiting block 612, the functions in blocks 610 and 612 are repeated until successful. After each successful data operation, a determination is made in decision block 614 whether additional operations are to be performed to complete the set of stripes. When it is determined that there are no additional sequences of data operations to process, the RAID converter 500 terminates the conversion process. When additional data operations remain, the RAID converter 500 performs the subsequent data operation as indicated in block 616 and repeats the functions of blocks 610 through 614 until the sequence of data operations is complete.

Exemplary steps for converting a logical volume are illustrated in FIG. 6. The particular sequence of the steps or functions in blocks 602 through 616 is presented for illustration. It should be understood that the order of the steps or functions in blocks 602 through 616 can be performed in any other suitable order.

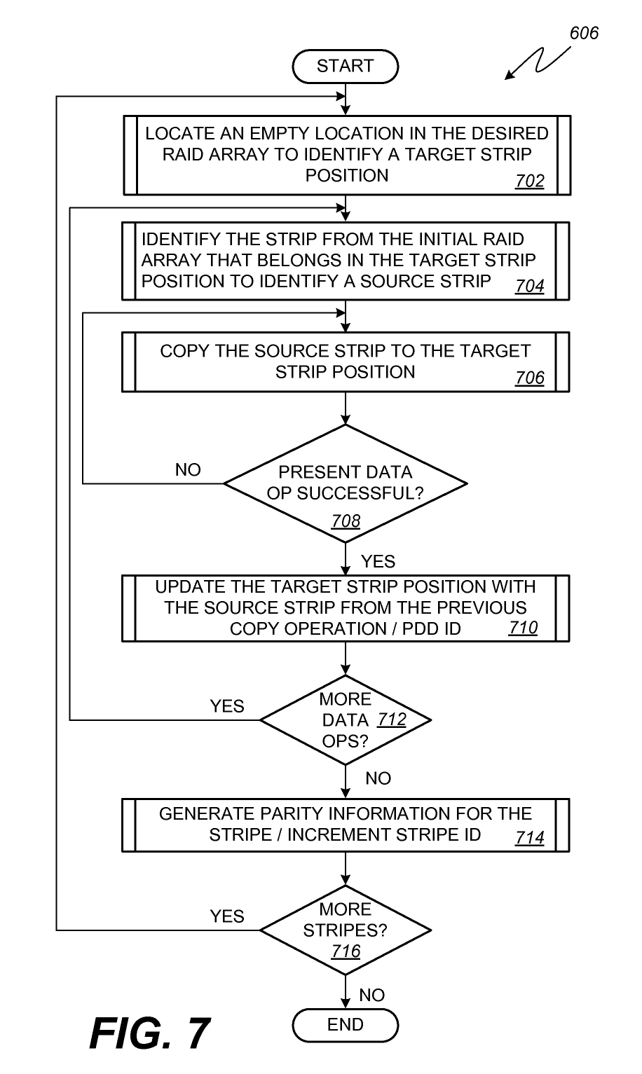

FIG. 7 is a flow diagram illustrating an embodiment of a method for transforming a stripe in a logical data volume. Method 606 begins with block 702 where an empty location in the desired RAID array is located to identify a target strip position. Next, as shown in block 704, the strip from the initial RAID array that belongs in the target strip position is identified to create a source strip. Thereafter, the source strip contents are copied to the target strip location as shown in block 706. In decision block 708, a determination is made whether the present data operation was successful. When the present operation failed, the RAID converter 500 returns to the retry the copy operation. When the present operation is successful, the RAID converter 500 updates the target strip position with the source strip from the previous copy operation. As further illustrated in block 710 the RAID converter 500 updates the physical disk drive representation or identifier stored in the non-volatile memory 530. When more data operations are to be performed to complete the stripe, as indicated by the flow control arrow exiting decision block 712, the RAID converter 500 repeats the functions in blocks 706 through 712, until the data strips for the stripe are populated. Thereafter, as indicated in block 714, the RAID converter 500 generates parity information for the stripe and increments the stripe identifier or representation in the non-volatile memory 530. Next, it is determined in decision block 716 if additional stripes are to be transformed. When it is determined that additional stripes are to be converted or transformed, the RAID converter 500 repeats the functions of blocks 702 through 716 until all stripes have been converted.

While various embodiments of the systems and methods for transforming or converting a RAID-based data storage volume have been described, it will be apparent to those of ordinary skill in the art that many more embodiments and implementations are possible that are within the scope of this disclosure. Accordingly, the described converter and methods are not to be restricted or otherwise limited except in light of the attached claims and their equivalents.

What is claimed is:

1. A method for transforming a first logical store from an initial logical arrangement to a desired logical arrangement where the initial and desired logical arrangements comprise different data structures, the method comprising:
identifying a first data structure of the initial logical arrangement and a second data structure of the desired logical arrangement, the first data structure comprising N physical disk drives where N is an integer, the second data structure comprising M physical disk drives where M is greater than or equal to N;
arranging a set of M physical disk drives in accordance with the second data structure;
identifying a select sequence of data operations that moves data from an original location in the initial logical arrangement to a target location in the desired logical arrangement, the select sequence of data operations accounting for, generating and locating parity information when the desired logical arrangement includes parity information; and
repeatedly executing the select sequence of data operations including:
recording information responsive to a present data operation in the desired logical arrangement; and
confirming a successful completion of the present data operation before commencing a subsequent data operation.

2. The method of claim 1, wherein identifying a select sequence of data operations comprises locating the parity information in response to a RAID level 5 variant selected from the group consisting of left hand, right hand, symmetric and asymmetric.

3. The method of claim 1, wherein recording information responsive to a present data operation in the desired logical arrangement comprises storing information in a non-volatile memory element.

4. The method of claim 3, wherein the information comprises a first digital representation of a present physical disk drive and a second digital representation of a present stripe.

5. The method of claim 4, wherein the information comprises a specified number of bytes.

6. The method of claim 4, wherein the first digital representation comprises 2 bytes.

7. The method of claim 4, wherein the second digital representation comprises 6 bytes.

8. The method of claim 1, further comprising performing multiple stripe data migrations substantially simultaneously when each multiple stripe is separate from its nearest neighbor multiple stripe by M stripes, where M is the number of physical disk drives in the second logical store.

9. The method of claim 1, wherein identifying a select sequence of data operations that moves data from an original location in the initial logical arrangement to a target location in the desired logical arrangement comprises for every M stripes moving a respective strip of data from an original location in a RAID array to a target location in a desired RAID array such that a strip of data from a first physical disk drive to a second physical disk drive is moved only once.

10. The method of claim 1, wherein when the present data operation is not confirmed successful, the present operation is repeated and confirmed before executing the subsequent data operation from the select sequence of data operations.

11. The method of claim 1, further comprising storing one or more select sequences of data operations in a lookup table.

12. The method of claim 1, wherein identifying a select sequence of data operations comprises:
locating an empty location in a desired RAID array to identify a target strip position;
identify a strip from the initial RAID array that belongs in the target strip position in the desired RAID array thereby identifying a source strip;
copying the source strip to the target strip position;
determining when the previous copy operation was unsuccessful, when so, repeating the copying of the source strip to the target strip position, otherwise, updating the target strip position with the source strip from the previous copy operation;
determining when additional data operations are required to complete a stripe in the desired RAID array, when so, repeating the identify, copying and determining steps, otherwise, generating and locating parity information for the stripe in the desired RAID array;
determining when additional stripes need to be translated, when so, repeating the previous method steps, otherwise, terminating the method.

13. A system for dynamically migrating a first logical store from an initial RAID array to a second logical store in a desired RAID array where the initial RAID array comprises a first data structure and the desired RAID array comprises a second data structure, the first data structure being different from the second data structure, the system comprising:
a memory element configured to store a select sequence of data operations that for every M stripes moves a respective strip of data from an original location in the initial RAID array to a target location in the desired RAID array, the select sequence of data operations accounting for, generating and locating a parity strip in each respective stripe when the desired RAID array includes parity information;
a processor coupled to the memory element and configured to execute the sequence of data operations, the processor executing a subsequent data operation from the sequence of data operations upon an indication that a previous data operation was successfully completed; and
a non-volatile memory element coupled to the processor and configured to hold information responsive to a present data operation, wherein when the indication reflects that a next previous data operation was not successful, the processor is configured to use the information in the non-volatile memory to execute a rollback operation and repeat the next previous data operation until successful completion.

14. The system of claim 13, further comprising a data integrity module in communication with the processor, the data integrity module generates an indication that a previous data operation was successful.

15. The system of claim 13, wherein the indication that a previous data operation was successfully completed is a binary flag.

16. The system of claim 13, wherein the rollback operation is responsive to the first data structure of the initial RAID array and the second data structure of the desired RAID array.

17. The system of claim 13, wherein the memory element comprises a table of at least one select sequence of data operations an entry in the table identified by both the first data structure of the initial RAID array and the second data structure of the desired RAID array.

18. The system of claim 13, wherein the non-volatile memory element stores a first digital representation of a present physical disk drive and a second digital representation of a present stripe.

19. The system of claim 18, wherein first digital representation comprises 2 bytes.

20. The system of claim 18, wherein the second digital representation comprises 6 bytes.
